(19) United States
(12) Patent Application Publication
(10) Pub. No.: US 2006/0080005 A1
(43) Pub. Date: Apr. 13, 2006

(54) Method for displaying a vehicle driving space

(76) Inventors: Wei-Chia Lee, Leonberg (DE); Markus Rossmeier, Benndorf (DE)

Correspondence Address: KENYON & KENYON LLP, ONE BROADWAY, NEW YORK, NY, 10004, US

(21) Appl. No.: 11/240,488

(22) Filed: Sep. 30, 2005

(30) Foreign Application Priority Data
Sep. 30, 2004 (DE) 102004047481.8

(51) Int. Cl. G06F 17/00

(52) U.S. Cl. 701/1; 701/36; 340/425.5

(57) ABSTRACT

A method for displaying a vehicle driving space, the vehicle driving space being depicted in perspective or in three dimensions, and a driving direction to be taken by the vehicle being displayed by way of a variation of the lighting conditions in the depiction.

### BACKGROUND INFORMATION

Driver assistance systems are already known that assist the driver when maneuvering and when entering and leaving parking spaces. Driver assistance systems have for this purpose, in particular, ultrasonic sensors that sense distances to obstacles in the vehicle's environment. If an obstacle comes too close to the vehicle, an optical and/or acoustic warning is outputted to the driver. Also known are systems that measure a parking space and, based on the parking space measurement, assist the driver with entry into the parking space. A parking assistance system of this kind is activated by a driver, in particular, when he or she wishes to be assisted with longitudinal entry, in reverse, into a parking space between two vehicles parked along the street. During an initial longitudinal pass alongside the parking space, the length of the parking space is measured by the system using suitable spacing sensors arranged, in particular, on the side of the vehicle. The distance traveled is also continuously measured, so that the vehicle's position can be established with respect to the position of the parking space. After driving past the parking space, the driver is requested to stop and to back into the parking space. While backing up, the driver is given indications by the driver assistance system as to how he or she can optimally back into the parking space, so as to enter the parking space without collisions and with as little steering effort or maneuvering effort as possible. In order to display the steering angle to the driver, it is known, for example, to display arrows that indicate to the driver whether to steer to the left or the right. If the driver needs to stop, a stop sign, for example, is displayed to him or her.

### SUMMARY OF THE INVENTION

The method according to the present invention for displaying a vehicle driving space has, in contrast, the advantage that information as to which driving direction the driver should select is displayed to the driver in a driving space of the vehicle that is depicted in perspective or three-dimensional fashion. The driving space, in this context, is the space in front of or behind the vehicle into which the driver can move the vehicle forward or backward, depending on the selected direction of travel. The driver can thus, by way of the depiction according to the present invention of the driving space, create a relationship between the steering direction of the vehicle and the vehicle driving space. It is particularly advantageous in this context that the steering direction is displayed to the driver by way of a variation in lighting conditions, in such a way that he or she can easily and intuitively perceive the steering angle. In particular because the lighting conditions can also be continuously varied, it is possible to convey to the driver in easily understandable fashion the extent to which he or she must apply a steering angle. This on the one hand prevents overcontrolling by the driver, and on the other hand makes possible a more accurate steering position. The fact that lighting conditions are utilized for a depiction additionally avoids flooding the driver with symbols, arrows, or similar indicators presented in the image, which might overload the driver.

It is particularly advantageous that the direction in which the driver is to drive is shown as brighter than a surrounding area. This highlighting makes a direction intuitively recognizable.

It is further advantageous to ascertain the depiction of the vehicle driving space from the distances sensed by surrounding-area sensors. It is thereby possible to display an image that corresponds, for example, to the space in back of the vehicle, with no need to provide a camera in the vehicle.

If a camera image is acquired, the driving space can easily be presented on the basis of the acquired images of the vehicle's environment. It is especially advantageous in this context to overlay the change in lighting conditions onto the image of the vehicle's environment.

It is further advantageous to provide light sources on the vehicle so that the variation in lighting conditions is generated by the light sources. This allows image post-processing to be dispensed with, if the area to the rear of the vehicle is imaged with a camera. This reduces the calculation outlay for image processing. It is further advantageous to indicate a target position of the vehicle, so that the driver can orient him- or herself on the target position when parking.

To warn the driver about obstacles, the obstacles can be particularly highlighted, especially by way of symbols in the display.

Especially when used for motor vehicle parking assistance, the method according to the present invention offers the advantage that a driver can intuitively follow the parking instructions depicted with the use of the method according to the present invention.

### BRIEF DESCRIPTION OF THE DRAWINGS

FIG. 1 shows a vehicle having a driver assistance system for carrying out the method according to the present invention.

FIG. 2 shows a schematically depicted parking situation.

FIGS. 3 and 4 show exemplary embodiments of display depictions according to the present invention in the context of the method according to the present invention.

### DETAILED DESCRIPTION

The method according to the present invention for displaying a vehicle driving space is used in particular in motor vehicles that participate in on-road traffic. In the depiction, the driving space located in front of the vehicle, but in particular also the driving space located behind the vehicle, can be depicted. Depiction of the space behind the vehicle is particularly advantageous, since the space behind the vehicle is generally more difficult to see, even in the case of a sedan, than the space located in front of the vehicle. Entering a parking space oriented parallel to the street, between two obstacles, generally constitutes a difficult driving maneuver. The present invention is therefore presented below with reference to a depiction of the space behind the vehicle in the context of a parking operation of this kind, i.e. entering a parking space oriented longitudinally with respect to the street.

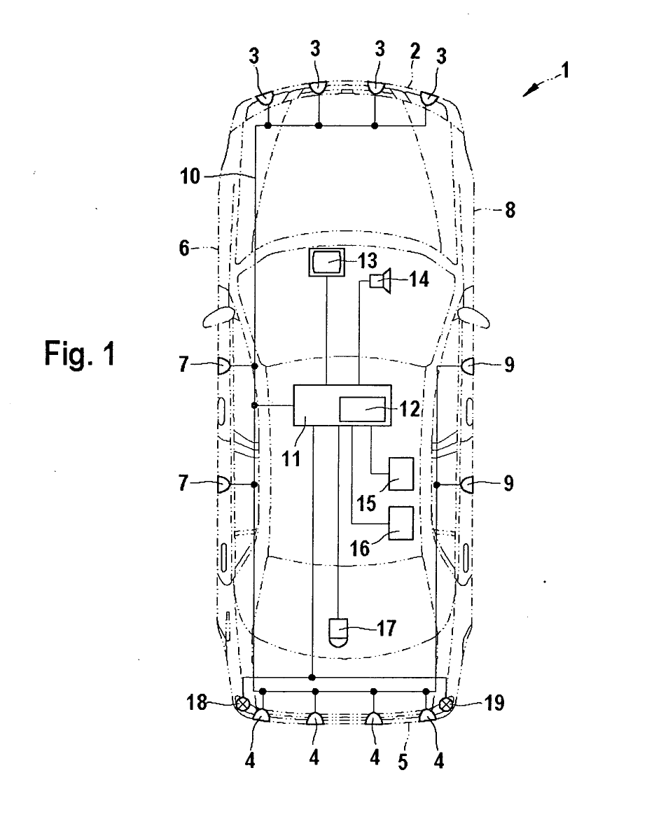

FIG. 1 schematically depicts a vehicle 1 that is equipped to carry out the method according to the present invention. Vehicle 1 has for this purpose distance sensors 3 on front end 2 of the vehicle that are preferably embodied as ultrasonic sensors. Instead of ultrasonic sensors, however, any other distance sensors, e.g. radar sensors or capacitative distance sensors, can also be used. Distance sensors 4 are likewise disposed on rear end 5 of the vehicle. In a preferred embodiment, distance sensors 7 can also be disposed on left side 6 of the vehicle in order to measure the parking space. In particular, distance sensors 9 are disposed on right side 8 of the vehicle. If applicable, different measurement technologies can also be used for the distance sensors. Preferably at least two distance sensors are disposed on sides 6, 8, and at least four in each case on front end 2 and rear end 5. The number of distance sensors can be varied. Distance sensors 3, 4, 7, 9 are evaluated via a data bus 10. The signals acquired are delivered for evaluation to an evaluation unit 11 that determines, from the distance data, the distances to obstacles in the vehicle's surroundings. Evaluation unit 11 has a calculation unit 12 for this purpose. If an obstacle comes too close to the vehicle, the driver is then warned via an optical display 13 and/or via a loudspeaker 14. Corresponding warning symbols can be presented in display 13, while a signal sound can be outputted via loudspeaker 14. Evaluation unit 11 can furthermore access a travel-distance sensor 15 that reports to evaluation unit 11 the distance that has been traveled. The distance traveled is ascertained, in particular, via wheel rotation speed sensors. Evaluation unit 11 furthermore accesses a steering angle sensor 16. Steering angle sensor 16 transmits to evaluation unit 11 the vehicle steering angle that is currently being applied.

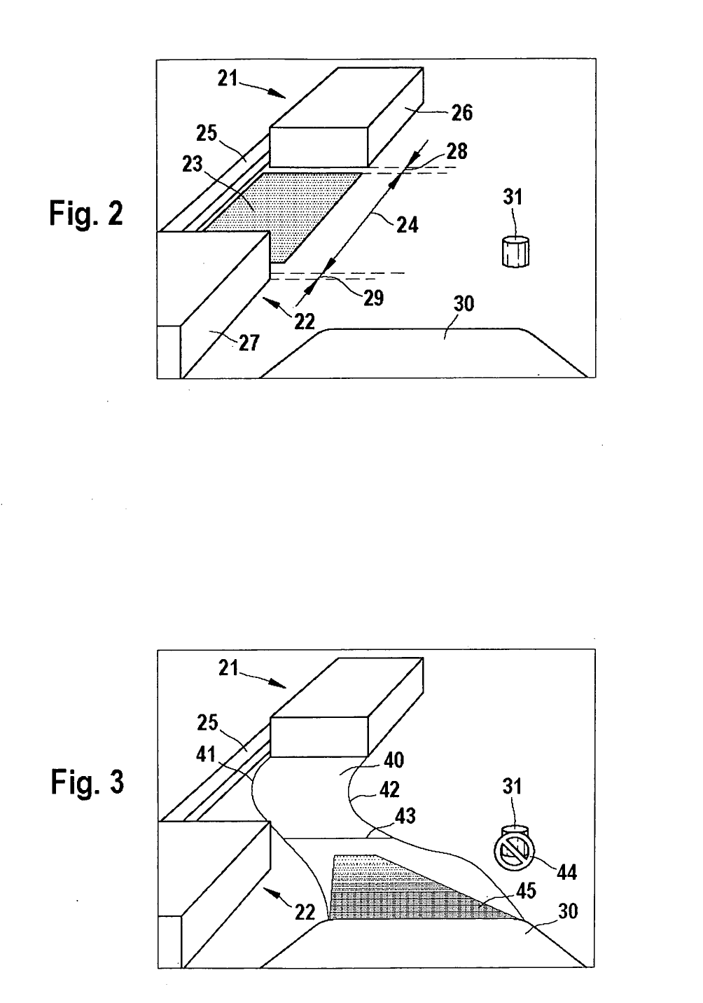

As vehicle 1 drives past a parking space, laterally disposed distance sensors 9, for example, measure the parking space. A corresponding parking space is depicted in FIG. 2. A parking space 23 having a sufficient length 24 has been identified between a first vehicle 21 and a second vehicle 22. A parking space exists when a sufficient depth is determined between a curb 25 and side surfaces 26 and 27 of the first and second vehicles, respectively. The parking space has a sufficient length if the parking space exhibits the requisite depth at least over a length that is necessary for parking the vehicle. A safe distance 28 from the first vehicle and a safe distance 29 from second vehicle 22 are taken into account in determining the parking space length. FIG. 2 shows a depiction of a space behind a vehicle as provided in display 13. For better orientation, a bumper 30 of vehicle 1 is also overlaid onto the image. In a first embodiment, the depiction shown in FIG. 2 can be calculated from the data acquired with the distance sensors. In another embodiment, the image depicted can also be acquired by a camera 17 that is mounted, in particular, on the rear end of vehicle 1. Camera 17 observes the space behind the vehicle. It is embodied, in particular, as a wide-angle camera. The image data sensed by camera 17 are delivered to evaluation unit 11. The acquired image data are preferably processed by calculation unit 12, in particular distortion-corrected, in the case of an extreme wide-angle image. The processed image data are presented on display 13. In a further embodiment, the acquired image data can also be first delivered in unprocessed form to display 13. Also evident in the driving space in FIG. 2 is an obstacle 31, for example a planter. The driver must not drive the vehicle against this obstacle 31 during the parking operation.

Once the parking space has been measured and the driver has driven the vehicle past the parking space, he or she is requested, by way of display 13 and/or loudspeaker 14, to stop the vehicle and then back into parking space 23. The target parking area is shown highlighted in FIG. 2. In order to reach the parking space, firstly a route is calculated that the vehicle must follow in order to reach the parking space.

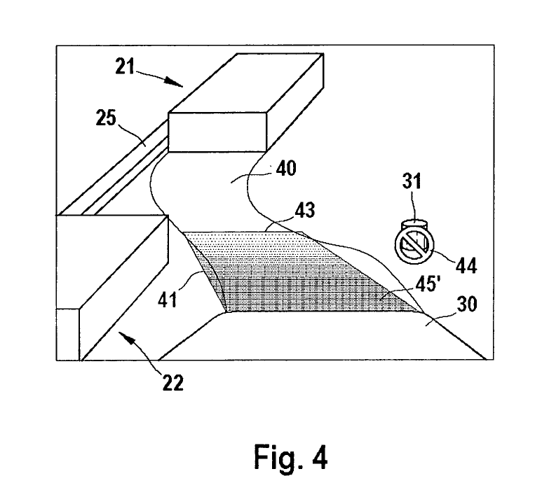

FIG. 3 shows a perspective depiction of the driving space. Display 13 is embodied, in particular, as a display in the center console of the vehicle. It serves, for example, as the output of a navigation system. In a further embodiment, display 13 can also be integrated into a combination instrument in the vehicle. It is moreover also possible to provide a three-dimensional display in the form of a so-called head-up display, with which a virtual image is projected onto a vehicle window, in particular onto the windshield.

In FIG. 3, this route that the vehicle is to follow is depicted on display 13 as trajectory 40 having a left boundary 41 and a right boundary 42. Also depicted is a deflection point 43 at which the driver must change the steering angle. By way of the display that is operated according to the present invention, the driver is given instructions for steering the vehicle into the parking space. For that purpose, a region 45 between left boundary 41, right boundary 42, bumper 30, and line 43 identifying the deflection point is highlighted. The boundary lines themselves need not be depicted, but such depiction may be possible in a further embodiment. In the exemplary embodiment presented here, region 45 is depicted as being brighter. In particular, the region toward left boundary 41 is depicted as being brighter. This brighter depiction oriented toward left boundary 41 informs the driver that he or she must turn the steering wheel to the left. The reason for this is that the current setting of the steering angle, sensed via steering angle sensor 16, indicates application of a steering angle that is directed too far to the right to allow trajectory 40 to be followed. To ensure that a correction can be correspondingly made, according to the present invention an indication is thus given to the driver to move the steering wheel to the left.

If the driver performs the necessary steering correction, the highlighted region expands to deflection point 43. The driver now knows that he or she can drive as far as the deflection point with no need to perform any further steering correction. He or she also recognizes this from the fact that the light distribution is now uniform in the entire driving space ahead of bumper 30. If the driver had turned the steering wheel too far to the left, area 45′ depicted in FIG. 4 would become smaller again, and a center point of the brightness would shift, starting from bumper 30, to the right toward right boundary 42. It is thus possible for a driver to effect a precise adjustment of the steering in order to reach the target (parking space 23).

Obstacle 31 is highlighted by a special warning symbol 44, so that a driver can pay particular attention to it in the presentation. In particular, however, the obstacle would also be particularly emphasized, e.g. colored red, if the highlighted path of the vehicle behind bumper 30 would intersect the position of the obstacle. A driver is thus made particularly aware of an obstacle positioned in such a fashion if it is located in his or her path. Instead of a brighter depiction, colored illumination can also be simulated in order to direct the driver's attention to the direction of travel that needs to be followed.

In a first embodiment, the depiction shown in FIGS. 3 and 4 is calculated by calculation unit 12 on the basis of the sensor data of distance sensors 3, 4, 7, 9, and outputted on display 13. In a further embodiment, it is also possible only to calculate region 45, 45′, and to superimpose it on an acquired camera image so that region 45, 45′ is depicted more brightly, according to the present invention, on display 13.

In a further embodiment, light sources 18, 19 that can be changeably controlled by evaluation unit 11 can also be disposed on the vehicle. In a first embodiment, these are light sources in visible light, so that a space behind the vehicle illuminated by the light sources is imaged by camera 17. The light impression according to FIGS. 3, 4 is generated in the image by corresponding activation of light sources 18, 19 by evaluation unit 11. The light sources can be integrated into the ordinary vehicle lights. They can also, however, be arranged on the vehicle as additional light sources.

In a further embodiment, light sources 18, 19 can also be infrared light sources, camera 17 in this case likewise being embodied as an infrared camera that is sensitive in the infrared region of the camera. The light sources then illuminate the area behind the vehicle with infrared light in such a way that regions 45, 45′ appear correspondingly on display 13. Illumination in the infrared region avoids any disturbance of other vehicles.

Light sources 18, 19 are equipped with a brightness controller, so they can be controlled to different brightness levels. They are directed toward the region behind bumper 30. If, for example, light source 19 arranged on right side 8 of the vehicle is operated at a higher level than light source 18 arranged on left side 6 of the vehicle, the impression depicted in FIG. 3 is produced. A directional orientation of the light sources in accordance with a trajectory that is to be followed can additionally be achieved by way of a pivotable optical system or pivotable baffles.

What is claimed is:

1. A method for displaying a driving space of a vehicle, comprising:
depicting the vehicle driving space in at least one of (a) perspective and (b) three dimensions; and
displaying at least one of (c) a current vehicle driving direction and (d) a driving direction to be taken by the vehicle by way of a variation of lighting conditions in the depiction of the vehicle driving space.

2. The method according to claim 1, wherein the direction in which the vehicle is to travel is depicted as brighter than a surrounding area.

3. The method according to claim 1, further comprising sensing distances to obstacles by way of surrounding-area sensors, and wherein the depiction of the vehicle driving space is determined from the distances to the obstacles that are sensed.

4. The method according to claim 1, further comprising sensing vehicle surroundings via a camera in order to depict the vehicle driving space.

5. The method according to claim 4, further comprising calculating a modification of the lighting conditions and superimposing the modification onto the depiction of the vehicle driving space that is sensed by the camera.

6. The method according to claim 4, further comprising activating light sources situated on the vehicle in such a way that the lighting conditions in a camera image of the vehicle driving space are varied.

7. The method according to claim 6, further comprising emitting infrared light by the light sources for illumination of the vehicle driving space.

8. The method according to claim 1, further comprising displaying a target position of the vehicle in the depiction of the driving space.

9. The method according to claim 1, further comprising identifying obstacles in the depiction by symbols.

10. The method according to claim 1, wherein the method is used for a parking assistance system of a motor vehicle.
